(19) United States
(12) Patent Application Publication
(10) Pub. No.: US 2008/0280786 A1
(43) Pub. Date: Nov. 13, 2008

(54) DEFOAMER/ANTIFOAMER COMPOSITIONS AND METHODS OF USING SAME

(75) Inventors: B. Raghava Reddy, Duncan, OK (US); Ronald E. Sweatman, Montgomery, TX (US); Lucas Fontanelle, Norman, OK (US)

Correspondence Address: CRAIG W. RODDY;HALLIBURTON ENERGY SERVICES, P.O. BOX 1431, DUNCAN, OK, 73536-0440, US

(73) Assignee: Halliburton Energy Services, Inc., Houston, TX (US)

(21) Appl. No.: 11/745,102

(22) Filed: May 7, 2007

(51) Int. Cl. C09K 8/035; C09K 8/10

(52) U.S. Cl. 507/104; 507/100; 507/127

(57) ABSTRACT

A method of servicing a wellbore comprising contacting a solid defoamer/antifoamer composition with a wellbore servicing fluid, wherein the solid defoamer/antifoamer composition comprises at least one water-insoluble compound or slightly water-soluble compound having defoaming/antifoaming activity and at least one emulsifier, and placing the wellbore servicing fluid in the wellbore.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This disclosure relates to servicing a wellbore. More specifically, it relates to servicing a wellbore with compositions comprising a solid defoamer/antifoamer and methods of using same.

2. Background of the Invention

Natural resources such as gas, oil, and water residing in a subterranean formation or zone are usually recovered by drilling a wellbore down to the subterranean formation while circulating a drilling fluid in the wellbore. After terminating the circulation of the drilling fluid, a string of pipe, e.g., casing, is run in the wellbore. The drilling fluid is then usually circulated downward through the interior of the pipe and upward through the annulus, which is located between the exterior of the pipe and the walls of the wellbore. Next, primary cementing is typically performed whereby a cement slurry is placed in the annulus and permitted to set into a hard mass (i.e., sheath) to thereby attach the string of pipe to the walls of the wellbore and seal the annulus. Subsequent secondary cementing operations may also be performed.

Wellbore servicing fluids such as for example drilling fluids, spacer fluids, cement slurries, fracturing fluids and the like may become foamed or have air entrapped during their preparation or subsequent use. There are a diverse set of chemical formulations that are found to be effective either to prevent foam (antifoamer) or to destroy it once it has been formed (defoamer). Most foam fighting chemicals can serve either role. The most universal characteristic of any defoamer/antifoamer is that it be surface active, but highly insoluble in water. The surface active-nature and low water solubility of these materials cause them to spread very rapidly on any air-water interface it encounters. This is especially the case if that interface is already covered by the types of surface active materials that tend to stabilize foams created during high speed mixing and pumping as is typical in oil field operations.

Defoamers/antifoamers may be added to wellbore servicing fluids at different points during the preparation of said fluids. For example, liquid defoamers/antifoamers are typically added to the mix water prior to the addition of solids. This approach is effective when liquid additives such as latexes which cause extensive foaming also need to be added to the water prior to the addition of any solids. On the other hand, solid defoamers/antifoamers may be dry blended with the solids of a composition prior to the addition of water or other fluids.

Solid defoamer/antifoamer compositions are typically prepared by spraying a liquid formulation of the defoamer/antifoamer onto an adsorbent material such as for example walnut shells such that the final materials remain as a dry solid. There are several drawbacks associated with the use of solid defoamer/antifoamer compositions. For example, the solid defoamer/antifoamer compositions are typically not as effective as the liquid formulations in either preventing the formation of foam or dissipating the foam once it has been generated. This may be due to the slow release of the active defoamer/antifoamer component from the adsorbent material. Thus, there exists an ongoing need for solid defoamer/antifoamer compositions that exhibit an effectiveness comparable to their liquid counterparts.

### SUMMARY OF THE PREFERRED EMBODIMENTS

Disclosed herein is a method of servicing a wellbore comprising contacting a solid defoamer/antifoamer composition with a wellbore servicing fluid, wherein the solid defoamer/antifoamer composition comprises at least one water-insoluble compound or slightly water-soluble compound having defoaming/antifoaming activity and at least one emulsifier, and placing the wellbore servicing fluid in the wellbore.

The foregoing has outlined rather broadly the features and technical advantages of the present disclosure in order that the detailed description that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the embodiments of the disclosure, reference will now be made to the accompanying drawings in which:

FIG. 1 is a plot of the slurry density as a function of added defoamer for the samples of Example 3.

### DETAILED DESCRIPTION OF THE PREFERRED EMBODIMENTS

In an embodiment, a method of servicing a wellbore comprises providing a solid defoamer/antifoamer composition (SDAC) and contacting the SDAC with a wellbore servicing fluid. The SDAC may comprise various combinations of a defoamer/antifoamer agent, an emulsifier, a filler, and optionally hydrophopic particles. The SDAC when contacted with a wellbore servicing fluid may allow for the rapid release of the defoamer/antifoamer agent into the wellbore servicing fluid which in turn may either prevent the entrapment of air in the fluid or reduce the amount of air entrapped in the fluid. A method of preparing a SDAC may comprise contacting at least one defoamer/antifoamer agent (e.g., water-insoluble compound (WIC) having defoamer/antifoamer activity) with an emulsifier to form an emulsified composition (EC) in water. The method further comprises removing the water from the EC to form the SDAC. The EC may further comprise a filler and/or hydrophobic particles. The defoamer/antifoamer agent (e.g., WIC), emulsifier, filler, hydrophobic particles, and other components of the SDAC will be described in more detail later herein.

In an embodiment, the SDAC comprises a defoamer/antifoamer agent. In an embodiment, the defoamer/antifoamer agent comprises one or more water-insoluble compounds (WICs) or slightly water-soluble compounds. Herein “slightly water-soluble compounds” refers to compounds which have less than about 10% solubility by weight in water. Hereinafter, for simplicity, the discussion will refer to the use of WICs although it is to be understood that slightly water-soluble compounds are also contemplated. The defoamer/antifoamer agent may comprise any WIC that is able to prevent and/or reduce the entrapment of air in a mixture to which it is introduced. In an embodiment, the WIC may comprise a silicon-containing liquid, a hydrocarbon base fluid, a co-solvent, glycerol tristearate, aliphatic hydrocarbons, or combinations thereof. WICs having defoamer/antifoamer activity of the type disclosed herein have been described in detail in U.S. Pat. Nos. 7,150,322 and 6,417,142 each of which are incorporated by reference herein in its entirety. Additional WICS for use as defoamer/antifoamers would be apparent to one of ordinary skill in the art.

In an embodiment, the defoamer/antifoamer agent comprises a silicon-containing liquid, alternatively an organosilane-containing liquid. The organosilane-containing liquid may comprise a silicone oil such as for example a polydialkylsiloxane. A polydialkylsiloxane suitable for use in this disclosure includes without limitation polydimethylsiloxane. Suitable silicone oils may have viscosities in the range of from about 1000 to about 10000 mPas. Suitable silicone oils that are commercially available for antifoamer/defoamer applications include for example and without limitation RHODORSIL ANTIFOAM 481 and RHODORSIL ANTIFOAM 416 available from Rhodia Corporation, France. Such silicon-containing defoamer/antifoamers are disclosed for example in U.S. Pat. No. 4,139,546 and U.S. Pat. No. 4,584,125 which are incorporated by reference herein in their entirety.

In another embodiment, the defoamer/antifoamer agent comprises a hydrocarbon base fluid in which the defoamer/antifoamer is incorporated by dissolution or dispersion. For example, the hydrocarbon base fluid may be a hydrocarbon that comprises an internal olefin. Alternatively, the hydrocarbon base fluids may comprise straight-chain n-alcohols, such as 1-hexanol, 1-octanol, 1-decanol, or combinations thereof. In certain embodiments, the straight-chain n-alcohols include those having between four and ten carbons. Optionally, the hydrocarbon base fluid also may be used in conjunction with a co-solvent, inter alia, to provide a more desirable flash point. Suitable co-solvents include, but are not limited to, ethylene glycol, propylene glycol, and combinations thereof. Other suitable co-solvents include ester-based fluids, such as PETROFREE LV, available from Halliburton Energy Services, Inc, which comprises an ester of 2-ethylhexanol and a plurality of monocarboxylic acids each comprising from about 6 to about 11 carbon atoms.

In an embodiment, the defoamer/antifoamer agent comprises a mixture of glycerol tristearate and one or more aliphatic hydrocarbons, for example one or more aliphatic hydocarbons selected from the group consisting of olefins having one or more internal double bonds and having 14 to 18 carbon atoms and a C₁₀ dimer of the formula:

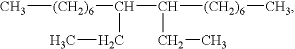

The one or more aliphatic hydrocarbons may comprise a mixture of C₁₆ to C₁₈ olefins having internal double bonds or a mixture of C₁₄ to C₁₆ olefins having internal double bonds or a dimer having the formula set forth above. Generally, the weight ratio of the glycerol tristearate to the one or more aliphatic hydrocarbons utilized is in the range of from about 5:95 to about 10:90. Alternatively, the weight ratio of the glycerol tristearate to the one or more aliphatic hydrocarbons is about 8.34:91.66. In an embodiment, the WIC is present in the SDAC in an amount ranging from about 20 to about 80%, alternatively from about 30 to about 70%, alternatively from about 40 to about 60% by weight of the composition.

In an embodiment, the SDAC comprises an emulsifier. Herein an emulsifier refers to a substance which stabilizes an emulsion wherein an emulsion refers to a mixture of two immiscible liquids of which one is in dispersed form, referred to as internal phase, and the other is in the continuous form, referred to as the external, bulk or continuous phase. When water is the external or continuous phase, the emulsion is referred to as oil-in-water (o/w) emulsion, and when water is the internal phase, the emulsion is referred to as water-in-oil emulsion (w/o).

In an embodiment the emulsifier comprises at least one partially hydrolysed protein. The material formed from the hydrolysis of the protein into protein fragments is termed the protein lysate. In an embodiment, the emulsifier comprises a protein lysate, alternatively a vegetable protein lysate. In an embodiment, the emulsifier comprises a partially hydrolysed vegetable protein whose degree of hydrolysis is greater than 0 and less than about 5%. The degree of hydrolysis of a protein is defined by the percentage of peptide bonds cleaved. The degree of hydrolysis can be determined either by using compounds which react specifically with amino groups involved in peptide bonds, or by directly titrating the amino acid groups. In general, the protein lysates according to the present disclosure can be obtained by chemical or enzymatic hydrolysis of the protein. Methods for the chemical or enzymatic hydrolysis of a protein to generate the protein lysate are known to one of ordinary skill in the art. Depending on the desired degree of hydrolysis, persons skilled in the art will know how to adjust the operating conditions for optimal hydrolysis. For example, the hydrolysis conditions may be similar to those described in Enzymic Hydrolysis of Food Proteins, Alder-Nissen, 1986, Elsevier Applied Science Publisher, London, incorporated by reference herein in its entirety.

In an embodiment, the emulsifier comprises protein lysates of at equal to or greater than about 10 amino acids alternatively, equal to or greater than about 15 amino acids. These protein lysates may comprise an amount by mass, of equal or greater than about half, alternatively equal or greater than about ⅔, alternatively equal or greater than about ¾ of the emulsifier. In another embodiment, the emulsifier comprises protein lysates having equal to or less than about 200 amino acids, alternatively equal to or less than about 100 amino acids. In such an embodiment the protein lysates may comprise an amount by mass of equal or greater than about half, alternatively equal or greater than about ⅔, alternatively equal or greater than about ¾ of the emulsifier. In an alternative embodiment, the emulsifier comprises protein lysates having between about 10 and about 100 amino acids, alternatively between about 15 and about 70 amino acids which are present in an amount by mass of equal or greater than about half, alternatively equal or greater than about ⅔, alternatively equal or greater than about ¾ of the emulsifier. In addition to the protein lysates as disclosed herein, the emulsifier may contain other agents known per se for their emulsifying action. The emulsifier may be present in the SDAC in a quantity of less than about 10%, alternatively between about 1% and about 3%, expressed as a percentage by mass relative to the defoamer/antifoamer agent. When partially hydrolyzed protein is used as the emulsifier, the emulsion is an o/w emulsion.

In an embodiment, the SDAC comprises a filler. This filler may exhibit a water-solubility, expressed as mass of solute over solvent mass, at least equal to 1%. In an embodiment, the filler comprises a high proportion of compounds having functions capable of giving so-called “hydrogen” bonds (e.g., acid, amide, amine, alcohol or thiol function and the like). In an embodiment, the filler is non-crystallizable under the operating conditions and in particular in the presence of the emulsifier. The filler may be present in an amount ranging from equal to or greater than about 10% to equal to or less than about 80%, expressed as a percentage by mass relative to the total dry matter (i.e., the total dry weight of the SDAC). Alternatively, the filler is present in an amount ranging from equal to or greater than about 20% to equal to or less than about 60%, expressed as a percentage by mass relative to the total dry matter.

The filler may comprise at least one water-soluble or water-dispersible compound which may be chosen from partially hydrolysed vegetable proteins (protein lysate). Alternatively, the filler comprises a partially hydrolysed vegetable protein whose degree of hydrolysis is in a range of from about 5% to about 40%. In an embodiment, the filler is obtained from a more extensive lysis of proteins (e.g., vegetable proteins), in particular to give protein fragments of which at least about ⅔ by mass have equal to or less than about 50 amino acids, alternatively equal to or less than about 20 amino acids. Methods for the lysis of proteins have been described previously herein. Emulsifiers and fillers of the type disclosed herein are described in U.S. Pat. No. 6,596,337 which is incorporated by reference herein in its entirety. In an embodiment, the emulsifier and the filler are the same partially hydrolysed proteins. In another embodiment, the emulsifier and the filler are different partially hydrolysed proteins.

The SDAC may optionally comprise particulates, alternatively hydrophobic particulates. In an embodiment, the hydrophobic particulate comprises silica. Without wishing to be limited by theory, the hydrophobic particulates may act in concert with the WIC and function to pierce the surface of any entrapped air bubbles thus reducing or preventing the foaming of the wellbore servicing fluid. A particulate hydrophobic silica useful in accordance with the present disclosure is precipitated silica treated at elevated temperatures with a hydrophobicizing agent such as a silicone oil (e.g. polydimethylsiloxane). The thermal treatment serves to chemically bond the hydrophobicizing agent to the hydrophilic silica surface.

Methodologies for the preparation of a particulate hydrophobic silica are known to one of ordinary skill in the art. For example, the particulate hydrophobic silica may be prepared from precipitated silica. The precipitated silica can be prepared by simultaneously adding sulfuric acid and sodium silicate solutions to water with agitation. The pH of the mixture during the reaction is maintained above about 9 whereby smaller particles are continuously dissolved during the precipitation of silica. As a result, uniform particle sizes are obtained. One skilled in the art may, during the production process vary parameters such as for example the ratio of reactants, the reaction time, the reaction temperature, the reaction mixture concentrations or combinations thereof to produce the desired precipitated silica. The precipitated silica may then be hydrophobized by spraying with a uniform coating of silicone oil followed by heating. The quantity of silicone oil utilized is usually about 10% by weight of the precipitated silica. Particularly suitable silicone oil treated precipitated silica for use in accordance with this disclosure is commercially available under the trade designations SIPERNAT D-11 and SIPERNAT D-13 from the Degussa Company having a place of business in Chester, Pa. The particle size of the hydrophobic particulate may be in the range of from about 1 to about 100 microns, alternately from about 5 to about 50 microns. The particulate hydrophobic silica may be included in the SDAC in an amount in the range of from about 0.1 to about 25%, alternatively from about 1 to about 15%, alternatively from about 3 to about 5%, expressed as a percentage by mass relative to the total dry matter (i.e., the total dry weight of the SDAC). Hydrophobic particulates of the type disclosed herein and their use in defoamer/antifoamer compositions are described in U.S. Pat. No. 6,297,202 which is incorporated by reference herein in its entirety.

In an embodiment, a method of preparing a SDAC comprises contacting at least one defoamer/antifoamer agent (e.g., WIC), at least one emulsifier, and at least one filler in an aqueous phase under conditions sufficient to form an EC. In an embodiment, the defoamer/antifoamer agent comprises a water-insoluble compound having defoaming/antifoaming activity (e.g. organosilane). One or more of the components of the SDAC may be provided as aqueous solutions and/or water may be added to form the aqueous phase. The water may be fresh water or salt water, e.g., an unsaturated aqueous salt solution or a saturated aqueous salt solution such as brine or seawater. Water may be present in the emulsion in a range of from about 40 to about 90%. Methods and equipment for the formation of an emulsion of the type disclosed herein are known to one of ordinary skill in the art and include for example and without limitation colloid milling.

In an embodiment, the method further comprises drying the EC to remove water and form a dry emulsion. Dry emulsion refers to a powder or solid material which when brought into contact with an aqueous phase re-forms an emulsion in which the particle size is close to that of the emulsion before drying. Methods and equipment for the drying of said emulsion such as for example and without limitation freeze drying, spray drying and the like are also known to one of ordinary skill in the art. The dry emulsion obtained using the methodology disclosed herein is a SDAC.

In an embodiment, the SDAC when prepared as disclosed herein may have a particle size of less than about 20 microns, alternatively less than about 40 microns, alternatively less than about 100 microns. Methods and equipment for the preparation of a dry emulsion of the type disclosed herein have been described in U.S. Pat. No. 6,596,337 which was previously incorporated by reference herein.

In an embodiment, the SDAC of this disclosure when contacted with or included in a wellbore servicing fluid may function as an antifoamer/defoamer to prevent or reduce the entrapment of air in said fluid. The SDAC of this disclosure when contacted with a wellbore servicing fluid may release the defoaming/antifoaming component of this composition in less than about 1 minute, alternatively less than about 30 seconds, alternatively less than about 10 seconds. In an embodiment, the release of the defoaming/antifoaming component of the SDAC occurs through the rapid dissolution, dispersion or degradation of the emulsifier and filler components of the SDAC. Herein the “rapid dissolution, dispersion or degradation” refers to the time duration necessary for the dissolution, dispersion or degradation of the emulsifier and filler being significantly shorter than the residence time of the wellbore servicing fluid in the preparation vessel (e.g., bulk mixer). The SDAC may be present in an amount of from about 0.05 to about 5% by weight of the solid blend in case of slurries (for e,g., a cement slurry) which may be prepared by adding solids to an aqueous solution. In case of emulsions (for example, a latex emulsion), or solutions containing at least one surfactant wherein foam formation may be undesirable, the SDAC composition may be present in an amount of from about 0.01 to about 3% by weight of the total composition.

The SDAC may be a component of a wellbore servicing fluid. As used herein, a “servicing fluid” refers to a fluid used to drill, complete, work over, fracture, repair, or in any way prepare a wellbore for the recovery of materials residing in a subterranean formation penetrated by the wellbore. The wellbore servicing fluid comprising a SDAC can be used for any purpose. In an embodiment, the wellbore servicing composition comprising a SDAC is used to service a wellbore that penetrates a subterranean formation, for example by pumping the wellbore servicing composition slurry comprising a SDAC downhole. It is to be understood that “subterranean formation” encompasses both areas below exposed earth and areas below earth covered by water such as ocean or fresh water. Examples of servicing fluids include, but are not limited to, cement slurries, drilling fluids or muds, spacer fluids, fracturing fluids or completion fluids, all of which are well known in the art. Without limitation, servicing the wellbore includes positioning a sealant composition (e.g., cement) in the wellbore to isolate the subterranean formation from a portion of the wellbore; to support a conduit in the wellbore; to plug a void or crack in the conduit; to plug a void or crack in a cement sheath disposed in an annulus of the wellbore; to plug an opening between the cement sheath and the conduit; to prevent the loss of aqueous or non-aqueous drilling fluids into loss circulation zones such as a void, vugular zone, or fracture; to be used as a fluid in front of cement slurry in cementing operations; to seal an annulus between the wellbore and an expandable pipe or pipe string; or combinations thereof.

For instance, the wellbore servicing fluid comprising a SDAC may viscosity in a loss-circulation zone and thereby restore circulation. The viscosified mixture can set into a flexible, resilient and tough material, which may prevent further fluid losses when circulation is resumed. The wellbore servicing fluid comprising a SDAC may withstand substantial amounts of pressure, e.g., the hydrostatic pressure of a drilling fluid or cement slurry, without being dislodged or extruded. The wellbore servicing fluids comprising a SDAC may provide a relatively viscous mass inside the loss-circulation zone. The wellbore servicing fluid comprising a SDAC can also form a non-flowing, intact mass inside the loss-circulation zone. This mass plugs the zone and inhibits loss of subsequently pumped drilling fluid, which allows for further drilling. Methods for introducing compositions into a wellbore are described in U.S. Pat. Nos. 5,913,364; 6,167,967; and 6,258,757, each of which is incorporated by reference herein in its entirety.

In an embodiment, the wellbore servicing fluids comprising a SDAC may be employed in well completion operations such as primary and secondary cementing operations. Said compositions may be placed into an annulus of the wellbore and allowed to set such that it isolates the subterranean formation from a different portion of the wellbore. The wellbore servicing fluids comprising a SDAC thus form a barrier that prevents fluids in that subterranean formation from migrating into other subterranean formations. Within the annulus, the fluid also serves to support a conduit, e.g., casing, in the wellbore.

In an embodiment, the wellbore in which the wellbore servicing fluid comprising a SDAC is positioned belongs to a multilateral wellbore configuration. It is to be understood that a multilateral wellbore configuration includes at least two principal wellbores connected by one or more ancillary wellbores. In secondary cementing, often referred to as squeeze cementing, the wellbore servicing fluid comprising a SDAC may be strategically positioned in the wellbore to plug a void or crack in the conduit, to plug a void or crack in the hardened sealant (e.g., cement sheath) residing in the annulus, to plug a relatively small opening known as a microannulus between the hardened sealant and the conduit, and so forth, thus acting as a sealant composition. Various procedures that may be followed to use a wellbore servicing composition in a wellbore are described in U.S. Pat. Nos. 5,346,012 and 5,588,488, which are incorporated by reference herein in their entirety.

In an embodiment, the SDACs of this disclosure are included in a cement slurry, for example a cement slurry comprising solid thermoplastic materials (e.g., elastomers). The SDACs of this disclosure may be dry blended into the cement slurry and act as an in situ deaerating agent which functions to reduce or prevent the entrapment of air caused by the inclusion of solid thermoplastic materials having air trapped in the surface irregularities of said materials. The presence of the SDAC in the formulation prior to the introduction of air from these solid materials having surface irregularities may result in the continuous defoaming of the slurry as these materials are incorporated and assist in the preparation of slurries having a desired density.

### EXAMPLES

The invention having been generally described, the following examples are given as particular embodiments of the invention and to demonstrate the practice and advantages thereof. It is understood that the examples are given by way of illustration and are not intended to limit the specification of the claims in any manner.

In the following Examples, the SDAC used was prepared and supplied as an experimental research and development sample as POUDRE SILICONE ANTIMOUSSE 481 by Rhodia Recherches, France according to set specifications. The dry powder contained antifoam/defoam silicone oil in 50% concentration by weight of the solid.

### Example 1

The ability of a SDAC to reduce foaming in a cement slurry was investigated. Two cement slurries, Samples 1 and 2 were prepared. Sample 1 comprised Class H cement, 35% by weight of cement (bwoc) SSA-2 sand, 37% by weight of water (bwow) NaCl, 49% bwoc hematite weighting agent, 3% bwoc HR-12 retarder, 0.6% bwoc HALAD-9 additive, 46% bwoc water and 0.25% bwoc of defoamer. HALAD-9 additive is a fluid loss control additive, SSA-2 is a coarse silica flour and HR-12 retarder is a lignosulfate/organic acid combination set retarder; all of which are commercially available from Halliburton Energy Services. Sample 2 comprised Class H cement, 37% bwow NaCl, 1% bwoc HR-12, 38.8% bwoc water and 0.25% bwoc defoamer. For each sample the defoamer was added to the mix water. Table 1 shows the design slurry density and the measured slurry density, both in pounds per gallon (ppg) for a high density slurry, Sample 1, and an intermediate density slurry, Sample 2, using either the SDAC of this disclosure or DAIR 4000L which is a liquid antifoaming agent commercially available from Halliburton Energy Services. For both Sample 1 and Sample 2 the DAIR 4000L is present at 100% active concentration while the SDAC is present at 50% active concentration.

TABLE 1

| | Sample 1 | | Sample 2 | |
|---|---|---|---|---|
| Density (ppg) | DAIR 4000 L | SDAC | DAIR 4000 L | SDAC |
| Design | 19.2 | 19.2 | 16.8 | 16.8 |
| Measured | 18.7 | 18.2 | 16.5 | 16.5 |

The results in Table 1 demonstrate that even at half the concentration of active material, the SDAC has a defoaming activity comparable to that of the antifoaming agent DAIR 4000L and is more effective in removing air from the cement slurry. Furthermore, the results show that a solid defoamer (SDAC) can be as effective as a liquid defoamer (DAIR 4000L) when added to the mix water.

### Example 2

The ability of a SDAC to reduce or prevent foaming in a latex cement slurry was investigated. Five samples of a cement slurry were prepared containing Class H cement, 2.0 gallons/sack of cement (gal/sk) LATEX 2000 emulsion, 0.19 gal/sk, STABILIZER 434B latex stabilizer, 0.5% bwoc dispersant and 19.8% bwoc water. LATEX 2000 emulsion is a styrene/butadiene copolymer latex and STABILIZER 434B latex stabilizer is an ethoxylated nonylphenol both of which are commercially available from Halliburton Energy Services. Sample 1 contained the liquid defoamer DAIR 4000L, Sample 2 contained another liquid defoamer DAIR 3000L, Sample 3 contained a solid defoamer DAIR 3000 while Samples 4 and 5 contained a SDAC. The defoamers were present in the amounts indicated in Table 2. DAIR 3000L and DAIR3000 are antifoaming agents commercially available from Halliburton Energy Services. All defoamers were added to the mix water with the exception of Sample 4 where the defoamer was added to the dry blend.

The slurry preparation procedure was modified for the latex-containing slurries described in this example. In the samples containing latex, defoamer, stabilizer and latex were added to the mix water that was being stirred in the blender at 1000 rpm, followed by the solid ingredients, in that order. The speed of the blender was then increased to 5000 rpm and the mixture stirred at that speed for 50 seconds. The fluid density of the mixture was measured in a pressurized mud balance. Density values for the samples are listed in the second row of Table 2. The stirrer speed was then increased to 12000 rpm and maintained at that speed for 35 seconds in accordance with API Recommended procedure.

TABLE 2

| | | Sample | Sample | Sample | Sample |
|---|---|---|---|---|---|
| Defoamer | Sample 1 | 2 | 3 | 4 | 5 |
| Amount of | 0.41 | 0.41 | 0.83 | 0.83 | 0.83 |
| Defoamer (% bwoc) | | | | | |
| Design Slurry | 16.4 | 16.4 | 16.4 | 16.4 | 16.4 |
| Density, ppg | | | | | |
| Measured slurry | 15.4 | 16.4 | 13.6 | 15.6 | 16.4 |
| (@ 5000 rpm) | | | | | |
| density (ppg) @ | | | | | |
| 5000 rpm | | | | | |
| blender speed | | | | | |
| Measured slurry | 14.9 | 15.4 | 13.8 | 14.9 | 15.5 |
| density at 12000 rpm* | | | | | |

*The slurry was prepared according API Recommended Practice 10B, Twenty-Third Edition, April 2002

The results demonstrate that samples having SDACs of the type disclosed herein (Samples 4 and 5) had slurry densities similar to the design slurry density and furthermore the SDACs displayed defoaming/antifoaming activity comparable to that of traditional defoamers/antifoamers.

### Example 3

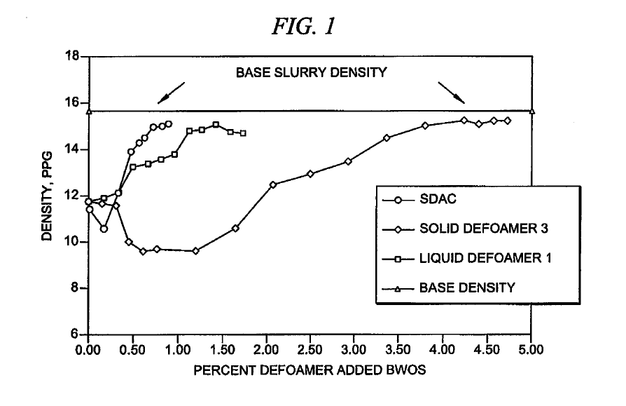

The defoaming ability of the SDACs of this disclosure was compared to other defoamers. Three samples of a foamed cement slurry were prepared by foaming Class A cement slurry with a slurry density of 15.57 ppg to 12.0 ppg by incorporating 23% air. The amount of water in the base slurry was 5.192 gal/sk. The slurry also contained 2% bwow ZONESEAL 2000 chemical, which is a foaming agent commercially available from Halliburton Energy Services. Small amounts of defoamer, by weight of slurry (bwos), were added at a time and the slurry was stirred for a few minutes until the gas evolution substantially stopped. The density of the slurry was then measured. To the partially defoamed slurry, more defoamer was added and the procedure was repeated. The results from this comparative study are shown in FIG. 1 where the solid defoamer and liquid defoamer were DAIR 3000 and DAIR 4000 respectively and are compared to the SDACs of this disclosure.

The results in FIG. 1 show a dramatic improvement in the defoaming efficiency of a solid defoamer using the SDACs of this disclosure when compared to the currently available solid defoamer. The SDAC of this disclosure is approximately 10 times more efficient than the currently available solid defoamer and shows a slight improvement over the liquid defoamers.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method of servicing a wellbore comprising:
contacting a solid defoamer/antifoamer composition with a wellbore servicing fluid, wherein the solid defoamer/antifoamer composition comprises at least one water-insoluble compound or slightly water-soluble compound having defoaming/antifoaming activity and at least one emulsifier; and
placing the wellbore servicing fluid in the wellbore.

2. The method of claim 1 wherein the solid defoamer/antifoamer composition releases a defoamer/antifoamer agent in less than about 1 minute.

3. The method of claim 1 wherein the solid defoamer/antifoamer composition is dry blended with a dry component of the wellbore servicing fluid prior to forming a pumpable wellbore servicing fluid.

4. The method of claim 3 wherein the solid defoamer/antifoamer composition is present in an amount of from about 0.05% to about 5% by weight of the solid blend.

5. The method of claim 1 wherein the solid defoamer/antifoamer composition is added to a wellbore servicing fluid emulsion or wellbore servicing fluid comprising a surfactant and is present in an amount of from about 0.01% to about 3% by total weight of the wellbore servicing fluid.

6. The method of claim 1 wherein the solid defoamer/antifoamer composition has a particle size of less than about 100 microns.

7. The method of claim 1 wherein the wellbore servicing fluid comprises a cement slurry, a drilling fluid, a spacer fluid, a fracturing fluid or combinations thereof.

8. The method of claim 1 wherein the water-insoluble compound or slightly water-soluble compound is present in an amount of from about 20% to about 80% by weight of the solid defoamer/antifoamer composition.

9. The method of claim 8 wherein the water-insoluble compound or slightly water-soluble compound comprises a silicon-containing compound, a hydrocarbon base-fluid, glycerol tristerate and one or more aliphatic carbons or combinations thereof.

10. The method of claim 9 wherein the silicon-containing compound comprises a silicone oil.

11. The method of claim 9 wherein the silicon-containing compound comprises a polydimethylsiloxane.

12. The method of claim 1 wherein the emulsifier is present in an amount of less than about 10% by mass relative to the defoamer/antifoamer agent.

13. The method of claim 1 wherein the emulsifier comprises a protein lysate.

14. The method of claim 13 wherein the protein lysate comprises a vegetable protein lysate.

15. The method of claim 1 wherein the solid defoamer/antifoamer composition further comprises a filler.

16. The method of claim 15 wherein the filler is present in a range of from equal to or greater than about 10% to equal to or less than about 80% by mass relative to the total dry matter.

17. The method of claim 15 wherein the filler comprises protein lysate.

18. The method of claim 1 wherein the solid defoamer/antifoamer composition further comprises a hydrophobic particulate.

19. The method of claim 18 wherein the hydrophobic particulate is present in an amount of from about 0.1% to about 25% by mass relative to the total dry matter.

20. The method of claim 18 wherein the hydrophobic particulate comprises silica.

21. The method of claim 18 wherein the hydrophobic particulate has a particle size of from about 1 to about 100 microns
